(19) United States
(12) Patent Application Publication
(10) Pub. No.: US 2014/0008006 A1
(43) Pub. Date: Jan. 9, 2014

(54) METHOD OF MANUFACTURING LITHIUM BATTERY

(71) Applicant: Electronics and Telecommunications Research Institute, (US)

(72) Inventors: Young-Gi Lee, Daejeon (KR); Kwang Man Kim, Daejeon (KR); Kunyoung Kang, Daejeon (KR); Dong Ok Shin, Daejeon (KR)

(73) Assignee: Electronics and Telecommunications Research Institute, Daejeon (KR)

(21) Appl. No.: 13/842,322

(22) Filed: Mar. 15, 2013

(30) Foreign Application Priority Data
Jul. 3, 2012 (KR) 10-2012-0072366
Nov. 2, 2012 (KR) 10-2012-0123651

(51) Int. Cl. H01M 4/139

(52) U.S. Cl. CPC H01M 4/139
USPC 156/150; 204/192.17; 29/623.2; 156/182

(57) ABSTRACT

Provided is a method of manufacturing a lithium battery. The method of manufacturing the lithium battery includes providing a anode part including a anode collector, a anode layer, and a anode electrolyte layer which are successively stacked on a first pouch film, providing a cathode part including a cathode collector, a cathode layer, and a cathode electrolyte layer which are successively stacked on a second pouch film, and sealing the first and second pouch films to couple the anode part to the cathode part.

### CROSS-REFERENCE TO RELATED APPLICATIONS

This U.S. non-provisional patent application claims priority under 35 U.S.C. §119 of Korean Patent Application Nos. 10-2012-0072366, filed on Jul. 3, 2012, and 10-2012-0123651, filed on Nov. 2, 2012, the entire contents of which are hereby incorporated by reference.

### BACKGROUND OF THE INVENTION

The present invention disclosed herein relates to a lithium battery, and more particularly, to a method of manufacturing a lithium battery.

As the importance of energy storage and conversion technologies is being emphasized, the interest with respect to lithium batteries is significantly increasing. Such a lithium battery may include a cathode, a separator, an anode, and an electrolyte. The electrolyte includes lithium salt and a solvent for dissociating the lithium salt. The electrolyte may serve as a medium through which ions are moved between the cathode and the anode. Since the lithium battery has a relatively high energy density than other batteries and is miniaturized and lightweight, the lithium battery is being actively researched and developed for a power source of potable electronic equipment. In recent, as the performance of portable electronic equipment is improved, the portable electronic equipment increases in power consumption. Thus, lithium batteries are required to have high power and good discharge characteristics. In addition, there is required that lithium batteries are automatically and continuously manufactured and mass-produced.

### SUMMARY OF THE INVENTION

The present invention provides a method of manufacturing a lithium battery having a large area and improved battery performance.

The feature of the present invention is not limited to the aforesaid, but other features not described herein will be clearly understood by those skilled in the art from descriptions below.

Embodiments of the present invention provide methods of manufacturing a lithium battery, the methods including: providing a anode part including a anode collector, a anode layer, and a anode electrolyte layer which are successively stacked on a first pouch film; providing a cathode part including a cathode collector, a cathode layer, and a cathode electrolyte layer which are successively stacked on a second pouch film; and sealing the first and second pouch films to couple the anode part to the cathode part.

In some embodiments, the providing of the anode part may include: depositing or sputtering copper on the first pouch film to form the anode collector; screen-printing anode paste on the anode collector to form the anode layer; and screen-printing electrolyte paste on the anode layer to form the anode electrolyte layer.

In other embodiments, the forming of the anode collector may further include forming an anode terminal contacting the anode collector on the first pouch film to protrude from the anode collector, wherein the anode terminal may be formed together with the anode collector by depositing or sputtering the copper.

In still other embodiments, the electrolyte paste may include a cellulose-based polymer, a polyvinylidene fluoride-based polymer, a lithium salt, an organic solvent, and an inorganic material.

In even other embodiments, the providing of the cathode part may include: depositing or sputtering aluminum on the second pouch film to form the cathode collector; screen-printing cathode paste on the cathode collector to form the cathode layer; and screen-printing electrolyte paste on the cathode layer to form the cathode electrolyte layer.

In yet other embodiments, the anode layer may include: a bottom surface contacting the anode collector; a top surface facing the bottom surface to contact the anode electrolyte layer; and a side surface connecting the bottom surface to the top surface, wherein the anode electrolyte layer may contact the top surface and the side surface.

In further embodiments, the cathode layer may include: a top surface; a bottom surface facing the top surface to contact the cathode collector; and a side surface connecting the top surface to the bottom surface, wherein the cathode electrolyte layer may contact the top surface and the side surface.

Embodiments of the present invention provide methods of manufacturing a lithium battery, the methods including: providing a anode part; providing a cathode part; and coupling the anode part to the cathode part to assemble the lithium battery, wherein the providing of the anode part includes: forming a anode collector on a first pouch film; forming a anode layer on the anode collector; and forming a anode electrolyte layer on the anode layer, wherein the providing of the cathode part includes: forming a cathode collector on a second pouch film; forming a cathode layer on the cathode collector; and forming a cathode electrolyte layer on the cathode layer.

In some embodiments, the forming of the anode collector may include depositing or sputtering copper on the first pouch film.

In other embodiments, the forming of the anode layer may include: mixing an anode active material, a conductive material, and electrolyte paste with each other to manufacture anode paste; and screen-printing the anode paste on the anode layer.

In still other embodiments, the forming of the anode electrolyte layer may include screen-printing electrolyte paste to cover the anode layer.

In even other embodiments, the forming of the cathode collector may include depositing or sputtering aluminum on the second pouch film.

In yet other embodiments, the forming of the cathode layer may include: mixing a cathode active material, a conductive material, and electrolyte paste with each other to manufacture cathode paste; and screen-printing the cathode paste on the cathode layer.

In further embodiments, the forming of the cathode electrolyte layer may include screen-printing electrolyte paste to cover the cathode layer.

In still further embodiments, the assembling of the lithium battery may include: stacking the anode part and the cathode part on each other to allow the negative and cathode electrolyte layers to contact each other; and thermally bonding the first and second pouch films to each other.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIGS. 1 to 13 are cross-sectional and plan views illustrating a method of manufacturing a lithium battery according to an embodiment of the present invention;

FIG. 14 is a view illustrating a process of manufacturing a anode part according to an embodiment of the present invention;

FIG. 15 is a graph illustrating results obtained by evaluating discharge characteristics of Experimental examples and Comparison examples;

FIG. 16 is a graph illustrating results obtained by evaluating impedance characteristics of Experimental example 1 and Comparison example 1; and

FIG. 17 is a graph illustrating results obtained by evaluating impedance characteristics of Experimental example 2 and Comparison example 2.

### DETAILED DESCRIPTION OF PREFERRED EMBODIMENTS

For sufficient understanding of configurations and effects of the present invention, preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. It would be understood to a person skilled in the art that the concept of the present invention may be performed under any adequate environments.

In the following description, the technical terms are used only for explain a specific exemplary embodiment while not limiting the present invention. The terms of a singular form may include plural forms unless referred to the contrary. The meaning of “include,” “comprise,” “including,” or “comprising,” specifies a component, a step, an operation and/or an element and/or a component but does not exclude other components, steps, operations, and/or elements.

It will be understood that when an element such as a film (or layer) or substrate is referred to as being “on” another element, it can be directly on the other element or intervening elements may also be present.

Also, though terms like a first, a second, and a third are used to describe various regions and layers in various embodiments of the present invention, the regions and the layers are not limited to these terms. These terms are used only to discriminate one region or film (or layer) from another region or film (or layer). Therefore, a layer referred to as a first layer in one embodiment can be referred to as a second layer in another embodiment. An embodiment described and exemplified herein includes a complementary embodiment thereof. It is also noted that like reference numerals denote like elements in appreciating the drawings.

Unless the terms used in the embodiments of the present invention are differently defined, the terms may be construed as commonly well-known meaning to a person skilled in the art.

Hereinafter, a method of manufacturing a lithium battery according to the present invention will be described in detail with reference to the accompanying drawings.

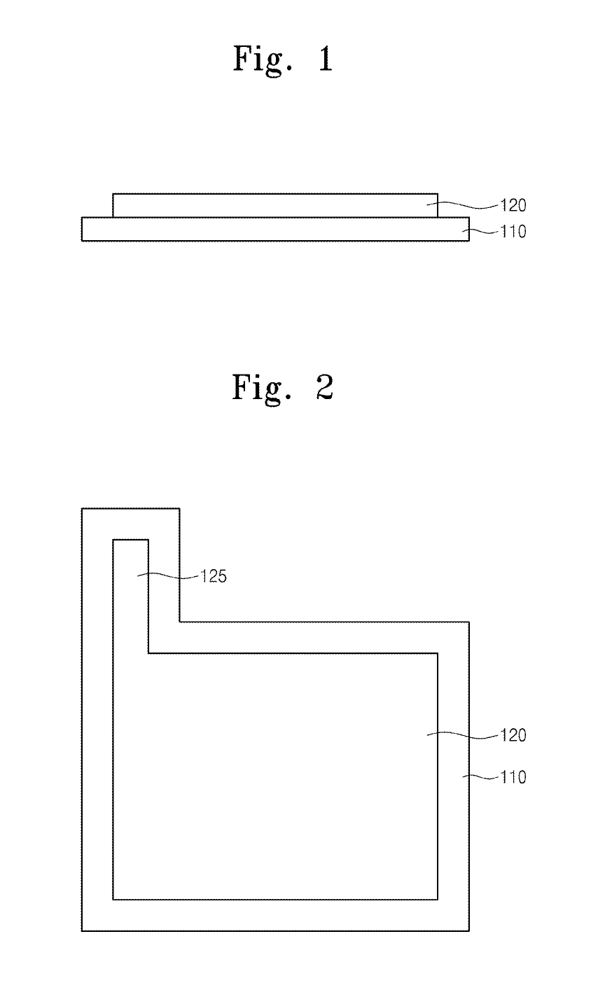

FIGS. 1 to 13 are cross-sectional and plan views illustrating a method of manufacturing a lithium battery according to an embodiment of the present invention.

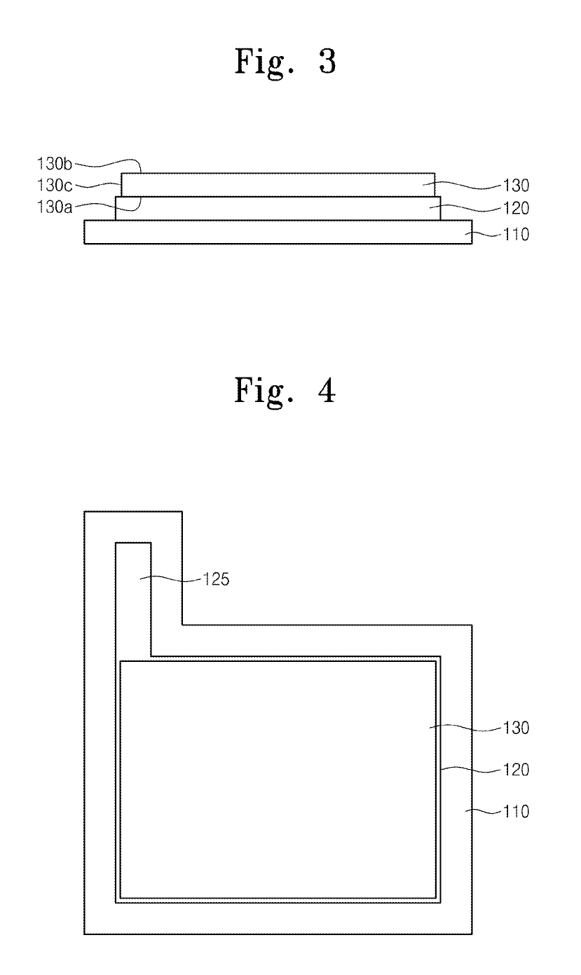

Referring to FIGS. 1 and 2, an anode collector 120 may be formed on a first pouch film 110. The first pouch film 110 may have a multi-layered structure and be formed of a metal layer such as aluminum, a polymer composite layer, or a combination thereof. A surface processing process may be performed on the first pouch film 110 to increase surface energy. The anode collector 120 may be formed by depositing or sputtering copper on the first pouch film 110. As the first pouch film 110 has high surface energy, the deposition process for forming the anode collector 120 may be easily performed. The anode collector 120 may have a sectional area less than that of the first pouch film 110. The anode collector 120 may have a thickness of about 2 μm to about 10 μm. An anode terminal 125 may contact the anode collector 120 on the first pouch film 110 to protrude from the anode collector 120. The anode terminal 125 may be formed together with an anode layer 130 by depositing or sputtering copper. Thus, a process for forming a separate anode terminal 125 may be omitted.

Referring to FIGS. 3 and 4, the anode layer 130 may be formed on the anode collector 120. The anode layer 130 may have a sectional area equal to or less than that of the anode collector 120. The anode layer 130 may include a bottom surface 130a contacting the anode collector 120, a top surface 130b facing the bottom surface 130a, and a side surface 130c connecting the bottom surface 130a to the top surface 130b. The anode layer 130 may have a thickness of about 15 82 m to about 150 μm. For example, the anode layer 130 may be formed by screen-printing anode paste on the anode collector 120. The anode paste may be manufactured by mixing an anode active material, a conductive material, and electrolyte paste (weight ratio about 6:2:2 to about 9.8:0.1:0.1). The anode active material may include a carbon-based material (e.g., graphite, hard carbon, soft carbon, or tin) or a non-carbon-based material (e.g., tin, silicon, lithium titanium oxide (LiₓTiO₂) nano tube, or spinel lithium titanium oxide (Li₄Ti₅O₁₂) coated with a carbon particle). The conductive material may include at least one of graphite, hard carbon, soft carbon, carbon fiber, carbon nano tube, carbon black, acetylene black, ketjen black, and a ronja carbon. The electrolyte paste will be described later. After the anode layer 130 is formed, a dry process and a roll pressing process may be further performed. For another example, a lithium foil may be pressed, and then the pressed lithium foil may be attached on the anode collector 120 to form the anode layer 130.

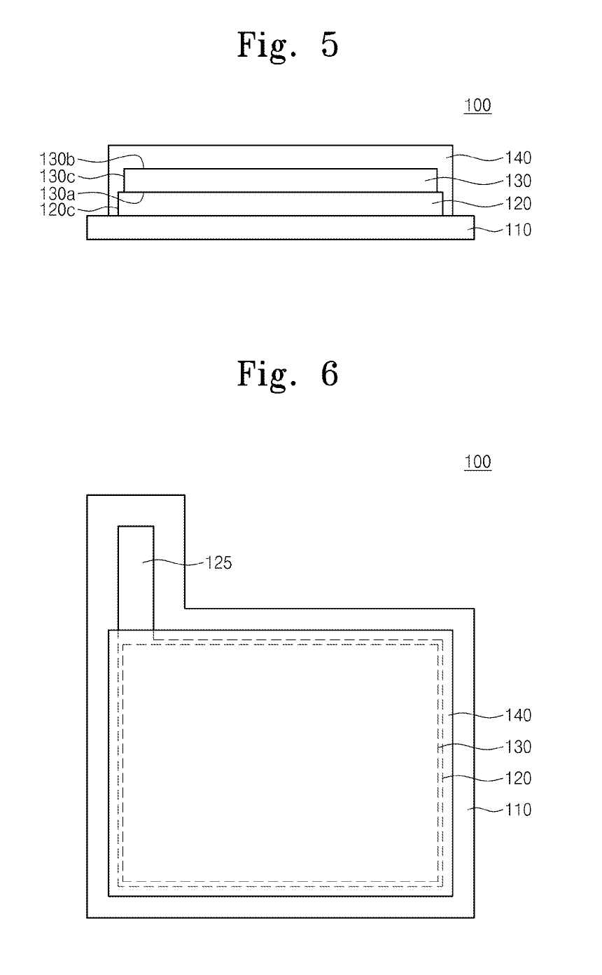

Referring to FIGS. 5 and 6, the electrolyte paste may be screen-printed on the anode layer 130 to form an anode electrolyte layer 140. After the screen printing, the anode electrolyte layer 140 may be dried. The anode electrolyte layer 140 may cover the anode collector 120 and the anode layer 130. For example, the anode electrolyte layer 140 may contact the top surface 130b and side surface 130c of the anode layer 130. Also, the anode electrolyte layer 140 may contact a side surface 120c of the anode collector 120. The anode electrolyte layer 140 may not cover the anode terminal 125. Thus, the anode terminal 125 may be exposed to the outside of the anode electrolyte layer 140.

A cellulose-based polymer and a polyvinylidene fluoride-based polymer may be mixed with each other, and then the mixture may be dissolved into a solvent to add a nonaqueous electrolyte solution and an inorganic material, thereby manufacturing the electrolyte paste. The cellulose-based polymer and the polyvinylidene fluoride-based polymer may be mixed at a weight ratio of about 1:99 to about 99:1. The cellulose-based polymer may have high adhesion and include cellulose, ethyl cellulose, butyl cellulose, carboxylmethyle cellulose, or hydroxypropyl cellulose. A polyvinylidene fluoride-based polymer may have a film formation characteristic. Also, the polyvinylidene fluoride-based polymer may include polyvinylchloride derivatives, acrylonitrile-based polymer derivatives, polyvinylidene fluoride, a copolymer of vinylidene fluoride and hexafluoropropylene, a copolymer of vinylidene fluoride and trifluoropropylene, a copolymer of vinylidene fluoride and tetrafluoropropylene, polymethylmethacylate, polyethylacrylate, polyethylmetacrylate, polybutylacrylate, polybutylmethacrylate, polyvinylacetate, polyvinylalcohol, polyimide, polysulfone, or polyurethane.

The nonaqueous electrolyte solution may be an organic solvent in which lithium salt is dissolved. The organic solvent may include at least one of ethylene carbonate, propylene carbonate, ethyl methyl carbonate, gammabutyrolactone, ethylene glycol, triglyme, polyethylene oxide, and polyethylene glycol dimethyl ether. The lithium salt may include at least one of lithium perchlorate (LiClO₄), lithium triplate (LiCF₃SO₃), lithium hexafluorophosphate (LiPF₆), lithium tetrafluorophosphate (LiBF₄), and lithium fluoromethanesulfonyl imide (LiN(CF₃SO₂)₂).

The inorganic particle may include an oxide-based inorganic particle, for example, lithium aluminum titanium phosphate (LATP), lithium aluminum germanium phosphate (LAGP), lithium lanthanum zirconium oxide (LLZO), lithium lanthanum titanium oxide, lithium lanthanum niobium oxide (LLNO), lithium lanthanum tallium oxide, or lithium barium lanthanum tallium oxide (LBLTO). The inorganic particle may have a size of about 500 nm to about 50 nm The electrolyte paste may be used for forming the anode electrolyte layer 140 as well as manufacturing anode paste and cathode paste.

The anode electrolyte layer 140 may have a thickness of about 5 μm to about 150 μm. A anode part 100 in which the first pouch film 110, the anode collector 120, the anode layer 130, and the anode electrolyte layer 140 are successively stacked on each other may be formed according to the above-described manufacturing processes.

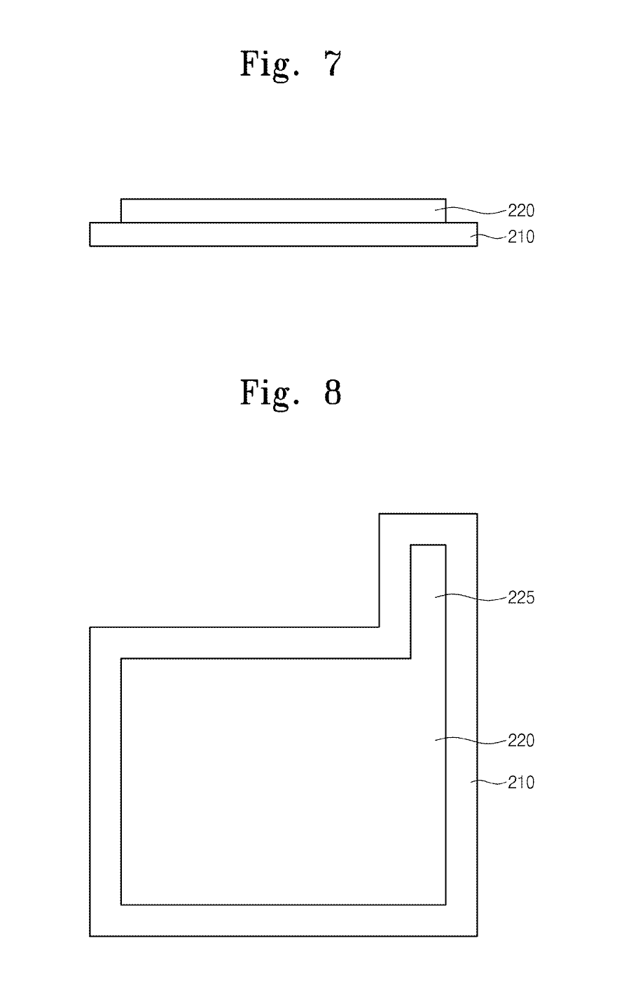

Referring to FIGS. 7 and 8, a cathode collector 220 may be formed on a second pouch film 210. The second pouch film 210 may be the same as the first pouch film 110 described in FIG. 1. A surface processing process may be performed on the second pouch film 210 to increase surface energy. The cathode collector 220 may be formed by depositing or sputtering aluminum on the second pouch film 210. The cathode collector 220 may have a sectional area less than that of the second pouch film 210. The cathode layer 220 may have a thickness of about 2 μm to about 10 μm. A cathode terminal 225 may contact the cathode collector 220 to protrude from the cathode collector 220. The cathode terminal 225 may be formed together with a cathode collector 220 by depositing or sputtering aluminum. Thus, a process for forming a separate cathode terminal 225 may be omitted.

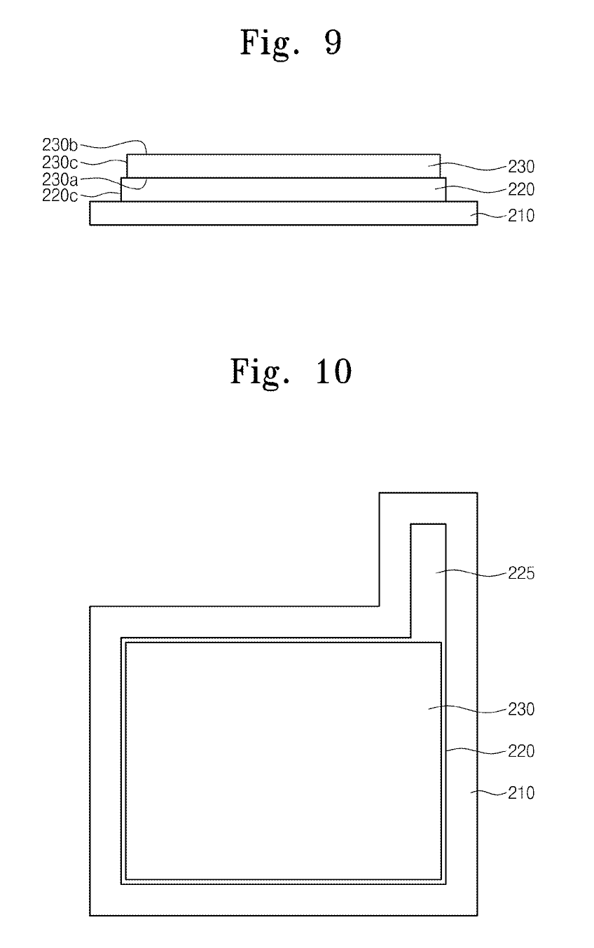

Referring to FIGS. 9 and 10, the cathode paste may be screen-printed on the cathode layer 220 to form a cathode layer 230. The cathode layer 230 may have a sectional area equal to or less than that of the cathode collector 220. The cathode paste may be manufactured by mixing a cathode active material, a conductive material, and electrolyte paste (weight ratio about 6:2:2 to about 9.8:0.1:0.1). The cathode active material may include lithium cobalt oxide (LiCoO₂), lithium nickel oxide (LiNiO₂), lithium manganese oxide (LiMn₂O₄), nano-sized olivine (LiFePO₄) coated with carbon particles, a mixture thereof, or a solid solution thereof. Each of lithium cobalt oxide (LiCoO₂), lithium nickel oxide (LiNiO₂), and lithium manganese oxide (LiMn₂O₄) may have a size of about 1 μm to about 100 μm. The conductive material and the electrolyte paste may have the same as those of FIGS. 3 to 6. A dry process and roll pressing process may be further performed. The cathode layer 230 may include a bottom surface 230a contacting the cathode collector 220, a top surface 230b facing the bottom surface 230a, and a side surface 230c connecting the bottom surface 230a to the top surface 230b. The cathode layer 230 may have a thickness of about 30 μm to about 150 μm.

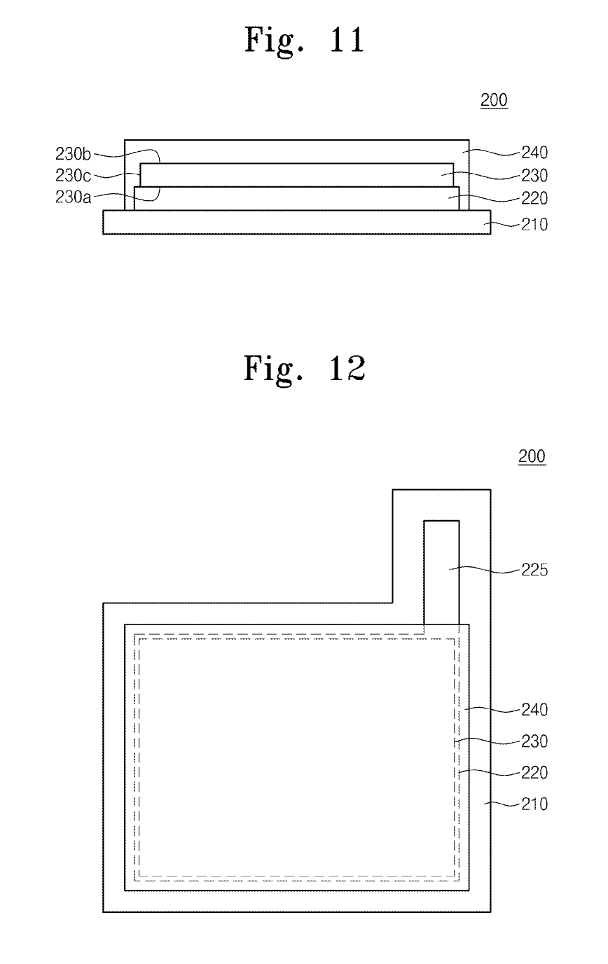

Referring to FIGS. 11 and 12, the electrolyte pate may be screen-printed to form a cathode electrolyte layer 240 on the positive layer 230. The electrolyte paste described in FIGS. 5 and 6 may be used. The dry process may be further performed on the cathode electrolyte layer 240. The cathode electrolyte layer 240 may cover the cathode collector 220 and the cathode layer 230. For example, the cathode electrolyte layer 240 may contact the top surface 230b and side surface 230c of the cathode layer 230. Also, the cathode electrolyte layer 240 may contact a side surface 220c of the cathode collector 220. The cathode electrolyte layer 240 may not be formed on the cathode terminal 225 to expose the cathode terminal 225. The cathode electrolyte layer 240 may have a thickness of about 5 μm to about 150 μm. Thus, a cathode part 200 in which the second pouch film 210, the cathode collector 220, the cathode layer 230, and the cathode electrolyte layer 240 are successively stacked on each other may be formed.

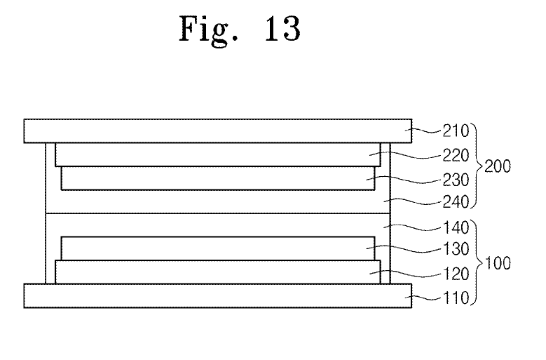

Referring to FIG. 13, the anode part 100 and the cathode part 200 are attached to each other to form a lithium battery 1. The cathode part 200 and the anode part 100 may be stacked on each other so that the anode electrolyte layer 140 contacts the cathode electrolyte layer 240. The first pouch film 110 and the second pouch film 210 may be thermally fused at a temperature of about 100° C. under a vacuum condition to seal a space therebetween. Thus, the anode part 100 and the cathode part 200 may be coupled to each other to allow the lithium battery 1 to be easily assembled. As the negative and cathode electrolyte layers 140 and 240 which include the same material physically contact each other, interface resistance of the lithium battery 1 may be reduced. Also, since the anode electrolyte layer 140 covers the anode layer 130, and the cathode electrolyte layer 140 covers the cathode 230, the anode layer 130 and the cathode layer 230 may not contact each other in the assembled lithium battery 1. Thus, short circuit of the lithium battery 1 may be prevented. Also, the anode layer 130 and the cathode layer 230 may be sealed to prevent the negative and cathode layers 130 and 230 from being damaged by external air or moisture. As a result, the lithium battery 1 may be improved in lifetime and stability.

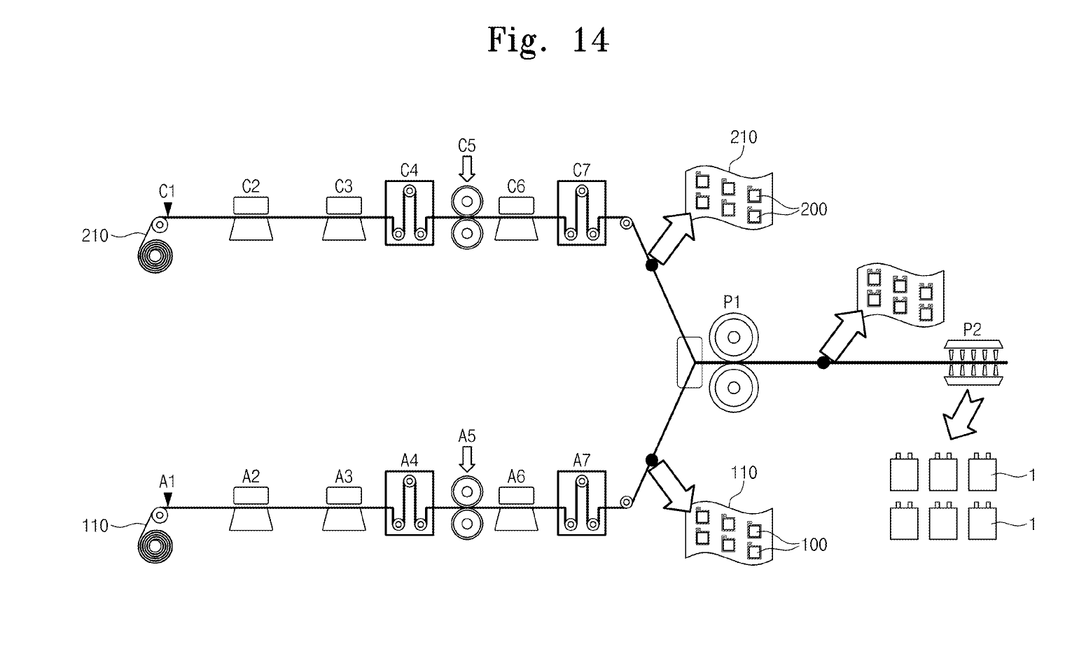

FIG. 14 is a view illustrating a process of manufacturing the anode part according to an embodiment of the present invention. Hereinafter, the process of manufacturing the anode part will be described together with reference to FIGS. 1 to 13.

Referring to FIG. 14, the anode part 100 may be continuously manufactured one at a time through a roll-to-roll process. For example, the first pouch film 110 may be surface-processed (A1), the anode collector 120 may be deposited on the first pouch film 110 (A2), the anode layer 130 may be formed (A3), the dry and roll pressing processes may be performed (A4 and A5), the anode electrolyte layer 140 may be formed (A6), and the dry process may be performed (A7) to manufacture the anode part 100. Also, the second pouch film 210 may be surface-processed (C1), the cathode collector 220 may be deposited on the second pouch film 210 (C2), the cathode layer 230 may be formed (3), the dry and roll pressing processes may be performed (C4 and C5), the cathode electrolyte layer 240 may be formed (C6), and the dry process may be performed (C7) to manufacture the cathode part 200. The anode part 100 may be manufactured one by one on the first pouch film 110, or a plurality of anode parts 100 may be manufactured on the first pouch film 110 at the same time. Also, the cathode part 200 may be manufactured one by one on the second pouch film 210, or a plurality of cathode parts 200 may be manufactured on the second pouch film 210 at the same time. The manufactured anode parts 100 and the cathode parts 200 may be coupled to each other (P1) and then slit (P2) to form the lithium battery 1. The method of manufacturing the lithium battery 1 according to an embodiment may be effective in automation, continuity, and mass-production.

Hereinafter, the method of manufacturing the lithium battery and results obtained by evaluating characteristics of the lithium battery according to the present invention will be described in more detail with reference to Experimental examples of the present invention.

Manufacture of Lithium Battery

### EXPERIMENTAL EXAMPLE 1

(Manufacture of Electrolyte Paste)

Ethyl cellulose is melted into N-methyl pyrrolidone (NMP), and a copolymer of vinylidene fluoride and hexafluoropropylene is melted to manufacture polymer matrix. The ethyl cellulose and the copolymer may have about 30 wt % and 70 wt %, respectively. Lithium hexafluorophosphate (LiPF₆) may be melted into an organic solvent to manufacture about 1 molar concentration of a nonaqueous electrolyte solution. The organic solvent is used by mixing about 1:1 weight ratio of ethylene carbonate (EC) and dimethyl carbonate. About 300 wt % of a nonaqueous electrolyte and about 30 w % of lithium aluminum titanium phosphate (LATP) may be added into the polymer matrix in order. Thereafter, a stirring process may be performed.

(Manufacture of Cathode Part)

A nylon layer, an aluminum foil, and a cast polypropylene layer may be laminated to form a pouch layer having a thickness of about 120 mm. The pouch layer may be processed by using a corona discharger under the atmosphere so that the pouch layer has surface energy of about 50 dyne/cm or more. The pouch layer may be provided within a vacuum chamber, and a collector layer may be deposited on the pouch layer to have a length of about 120 mm, a width of about 87 mm, and a height of about 8 mm. The deposition process may be performed by using aluminum for a time of about 15 minutes under the high vacuum condition. Also, a metal terminal contacting the deposited aluminum collector layer may be formed together. About 10 wt % of the electrolyte paste, about 85 wt % of lithium cobalt oxide (LiCoO₂), and about 5 wt % of acetylene black may be mixed with each other to manufacture cathode paste. The cathode paste may be applied on the aluminum collector layer to a thickness of about 100 μm. Also, the electrolyte paste may be directly applied again on a surface of the cathode layer formed as described above to form an organic/inorganic hybrid solid electrolyte layer on the surface of the cathode layer.

(Manufacture of Anode Part)

An anode part may be manufactured through the same process as that of the cathode part. However, a collector layer may be deposited by using copper. Anode paste which is manufactured by mixing about of 10 wt % of electrolyte paste, about 85 wt % of natural graphite, and about 5 wt % of acetylene black with each other may be applied on a copper collector layer to a thickness of about 50 μm. Also, the electrolyte paste may be directly applied again on a surface of the anode layer formed as described above to form an organic/inorganic hybrid solid electrolyte layer on the surface of the anode layer.

(Manufacture of Lithium Battery)

A cathode part and an anode part which are formed on a pouch film contact each other to seal four corners of the pouch film through vacuum thermal bonding, thereby manufacturing a lithium battery.

### EXPERIMENTAL EXAMPLE 2

A lithium battery may be manufactured through the same method as that of Experimental example 1. However, cathode paste manufactured by mixing about 10 wt % of cathode paste, about 85 wt % of olivine (LiFePO₄), and about 5 wt % of acetylene black with each other may be used.

### COMPARISON EXAMPLE 1

(Manufacture of Electrolyte Film)

Electrolyte paste which is the same as that of Experimental example 1 may be casted on a release paper to evaporate N-methylpyrrolidone (a co-solvent), thereby manufacturing an organic/inorganic hybrid solid electrolyte film.

(Manufacture of Cathode Part)

A collector layer is formed using carbon paste. An electrode plate may be manufactured through the same method as that of Experimental example 1 except that a cathode layer uses a polyvinylidene fluoride binding material instead of the electrolyte paste. Here, the formation of the electrolyte layer on a cathode plate through the coating of the electrolyte paste may be omitted.

(Manufacture of Anode Part)

A collector layer is formed using carbon paste. An electrode plate may be manufactured through the same method as that of Experimental example 1 except that an anode layer uses a polyvinylidene fluoride binding material instead of the electrolyte paste. Here, the formation of the electrolyte layer on an anode plate through the coating of the electrolyte paste may be omitted.

(Manufacture of Lithium Battery)

The cathode plate manufactured as described above, the casted organic/inorganic hybrid solid electrolyte film, and the anode plate may be stacked on each other to manufacture a lithium battery.

### COMPARISON EXAMPLE 2

A lithium battery is manufactured through the same method as that of Comparison example 1. However, cathode paste manufactured by mixing about 10 wt % of polyvinylidene fluoride, about 85 wt % of olivine (LiFePO₄), and about 5 wt % of acetylene black with each other may be used.

Evaluation of Lithium Battery Performance

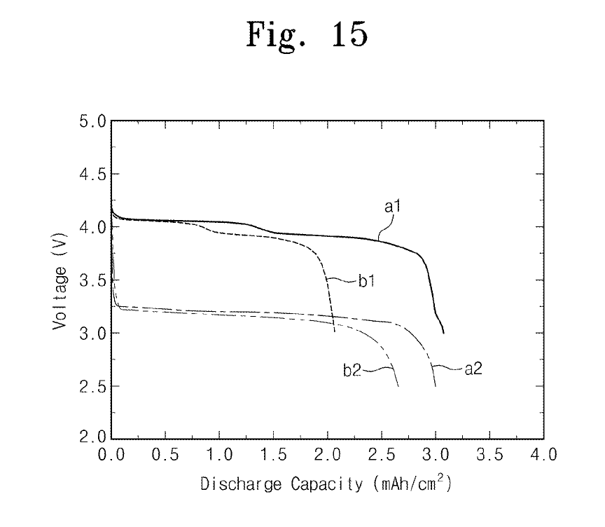

FIG. 15 is a graph illustrating results obtained by evaluating discharge characteristics of Experimental examples and Comparison examples. In a discharge characteristic evaluation test, a lithium battery is discharged to measure a voltage (a vertical axis) according to a discharge capacity (a horizontal axis). Hereinafter, this will be described together with reference to FIG. 13.

Referring to FIG. 15, it is seen that Experimental example 1 (a1) has a discharge capacity greater than those of Comparison examples 1 and 2 (b1 and b2), and Experimental example 2 (a2) has a discharge capacity greater than that of Comparison example 2 (b2). Experimental examples 1 and 2 (a1 and a2) has a discharge capacity value of about 3.0 maAh/cm² or more.

In Experimental examples 1 and 2 (a1 and a2), the anode layer 130 and the cathode layer 230 of the lithium battery 1 may be respectively covered by the anode electrolyte layer 140 and the cathode electrolyte layer 240 to maximize the contact between the anode layer 130 and the anode electrolyte layer 140 and between the cathode layer 230 and the cathode electrolyte layer 240. Thus, electron conduction and collection characteristics of the lithium battery 1 may be improved to increase performance of the lithium battery 1.

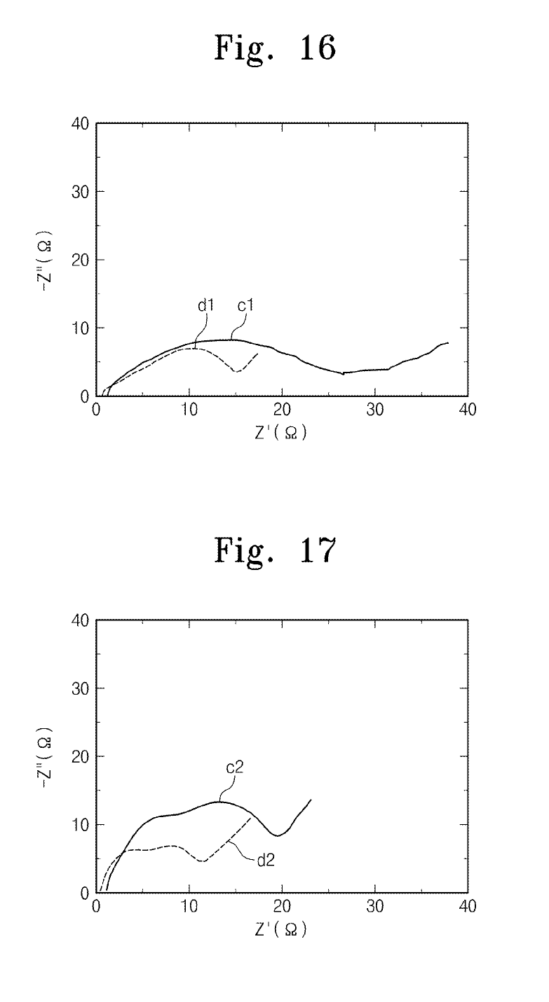

FIG. 16 is a graph illustrating results obtained by evaluating impedance characteristics of Experimental example 1 and Comparison example 1, and FIG. 17 is a graph illustrating results obtained by evaluating impedance characteristics of Experimental example 2 and Comparison example 2. Hereinafter, this will be described together with reference to FIG. 13.

Referring to FIGS. 16 and 17, it is seen that Experimental example 1 (d1) has internal resistance less than that of Comparison example 1 (c1), and Experimental example 2 (d2) has internal resistance less than that of Comparison example 2 (c2). In Experimental examples 1 and 2 (c1 and c2), the anode collector 120, the anode layer 130, and the anode electrolyte layer 140 may be directly applied on the first pouch film 110 to manufacture the anode part 100, and then the cathode part 200 manufactured by directly applying the cathode collector 220, the cathode layer 230, and the cathode electrolyte layer 240 on the second pouch film 210 may be coupled to the anode part 100. Thus, a physical pore between interfaces therebetween may be minimized, and adhesion therebetween may be improved. Therefore, the lithium battery 1 having internal resistance may be manufactured to improve the performance of the lithium battery 1. The negative and cathode parts 100 and 200 may be continuously manufactured at a time on the pouch films 110 and 210 through the direct coating. A process for packing the lithium battery 1 by using the pouch films 110 and 210 may be omitted. According to the method of manufacturing the lithium battery of the present invention, the lithium battery 1 may be easily manufactured with a large area and be effective in automation, continuity, and mass-production.

The method of manufacturing the lithium battery according to the present invention may include a process of providing the cathode part and a process of sealing the first and second pouch films through the vacuum thermal bonding to couple the anode part to the cathode part. The negative and cathode parts may be continuously manufactured at a time on the pouch films by directly applying the collector layer, the electrode layer, and the electrolyte layer. Since the negative and cathode electrolyte layers 140 and 240 which include the same material physically contact each other, the interface resistance of the lithium battery may be reduced. Also, the electron conduction and collection characteristics of the lithium battery may be improved to improve the performance of the lithium battery. In the method of manufacturing the lithium battery according to the embodiment, the lithium battery having the large area may be effectively manufactured.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of manufacturing a lithium battery, the method comprising:
providing an anode part comprising an anode collector, an anode layer, and an anode electrolyte layer which are successively stacked on a first pouch film;
providing a cathode part comprising a cathode collector, a cathode layer, and a cathode electrolyte layer which are successively stacked on a second pouch film; and
sealing the first and second pouch films to couple the anode part to the cathode part.

2. The method of claim 1, wherein the providing of the anode part comprises:
depositing or sputtering copper on the first pouch film to form the anode collector;
screen-printing anode paste on the anode collector to form the anode layer; and
screen-printing electrolyte paste on the anode layer to form the anode electrolyte layer.

3. The method of claim 2, wherein the forming of the anode collector further comprises forming a anode terminal contacting the anode collector on the first pouch film to protrude from the anode collector,
wherein the anode terminal is formed together with the anode collector by depositing or sputtering the copper.

4. The method of claim 2, wherein the electrolyte paste comprises a cellulose-based polymer, a polyvinylidene fluoride-based polymer, a lithium salt, an organic solvent, and an inorganic material.

5. The method of claim 1, wherein the providing of the cathode part comprises:
depositing or sputtering aluminum on the second pouch film to form the cathode collector;
screen-printing cathode paste on the cathode collector to form the cathode layer; and
screen-printing electrolyte paste on the cathode layer to form the cathode electrolyte layer.

6. The method of claim 1, wherein the anode layer comprises:
a bottom surface contacting the anode collector;
a top surface facing the bottom surface to contact the anode electrolyte layer; and
a side surface connecting the bottom surface to the top surface,
wherein the anode electrolyte layer contacts the top surface and the side surface.

7. The method of claim 1, wherein the cathode layer comprises:
a top surface;
a bottom surface facing the top surface to contact the cathode collector; and
a side surface connecting the top surface to the bottom surface,
wherein the cathode electrolyte layer contacts the top surface and the side surface.

8. A method of manufacturing a lithium battery, the method comprising:
providing an anode part;
providing a cathode part; and
coupling the anode part to the cathode part to assemble the lithium battery,
wherein the providing of the anode part comprises:
forming an anode collector on a first pouch film;
forming a anode layer on the anode collector; and
forming a anode electrolyte layer on the anode layer,
wherein the providing of the cathode part comprises:
forming a cathode collector on a second pouch film;
forming a cathode layer on the cathode collector; and
forming a cathode electrolyte layer on the cathode layer.

9. The method of claim 8, wherein the forming of the anode collector comprises depositing or sputtering copper on the first pouch film.

10. The method of claim 8, wherein the forming of the anode layer comprises:
mixing a anode active material, a conductive material, and electrolyte paste with each other to manufacture anode paste; and
screen-printing the anode paste on the anode layer.

11. The method of claim 8, wherein the forming of the anode electrolyte layer comprises screen-printing electrolyte paste to cover the anode layer.

12. The method of claim 8, wherein the forming of the cathode collector comprises depositing or sputtering aluminum on the second pouch film.

13. The method of claim 8, wherein the forming of the cathode layer comprises:
mixing a cathode active material, a conductive material, and electrolyte paste with each other to manufacture cathode paste; and
screen-printing the cathode paste on the cathode layer.

14. The method of claim 8, wherein the forming of the cathode electrolyte layer comprises screen-printing electrolyte paste to cover the cathode layer.

15. The method of claim 8, wherein the assembling of the lithium battery comprises:
stacking the anode part and the cathode part on each other to allow the negative and cathode electrolyte layers to contact each other; and
thermally bonding the first and second pouch films to each other.
